(19) United States
(12) Patent Application Publication
(10) Pub. No.: US 2006/0163354 A1
(43) Pub. Date: Jul. 27, 2006

(54) System and method of product identification, authentication and verification

(76) Inventors: Robert P. Tyranski, Livonia, MI (US); Patrick J. McGowan, Howell, MI (US)

Correspondence Address: ROBERT P. TYRANSKI, 14411 HARRISON STREET, LIVONIA, MI, 48154, US

(21) Appl. No.: 11/040,421

(22) Filed: Jan. 21, 2005

(51) Int. Cl. G06K 7/10; G06F 17/00

(52) U.S. Cl. 235/454; 235/375

(57) ABSTRACT

An item identification and verification system embeds a secondary machine-detectable symbology within a primary machine-detectable symbology. The primary machine-detectable symbology includes a first decodable multi-dimensional structure and is permanently formed on an item of manufacture. A secondary machine-detectable symbology forms at least a discrete portion of the primary machine-detectable symbology. The secondary machine-detectable symbology may have a second decodable structure that is different from the first decodable multi-dimensional structure of the primary machine-detectable symbology.

### FIELD OF THE INVENTION

The present invention relates to a product identification, authentication and verification system. More particularly, the present invention relates to a system wherein a machine-detectable product identification, authentication and verification mark is concealed within a primary symbology permanently attached to a product.

### BACKGROUND OF THE INVENTION

Over the past two decades, international commerce has increasingly experienced problems of counterfeit goods. Currently, counterfeiting is a multi-billion dollar industry experiencing unprecedented growth, because counterfeiters are able to initiate their business efforts for minimal initial investment, and are able to find locations worldwide that minimize the risk of prosecution. Today, there exists wide-scale copying of products as diverse as automotive parts, electronic components, pharmaceuticals, food products, aircraft parts, consumer goods, sports equipment, computer chips, cosmetics, and chemicals. Each counterfeit item available on the market not only deprives the rightful manufacturer of such good of profit, but also has potential adverse consequences beyond profit and loss. For example, the increased availability of counterfeit goods has increased the consumer's contact to substandard and potentially unsafe products while exposing the rightful manufacturer to reputation, liability and litigation risks.

Counterfeiting is enabled by the availability of enhanced technology that allows a counterfeiter to mass-produce and distribute authentic looking products and packaging. For example, the availability of sophisticated digital equipment like photo-quality scanners and printers helps the counterfeiter produce nearly identical copies of a legitimate company's packaging, documentation, logos, or labels for their counterfeit products, thereby effectively camouflaging what may very well be a substandard product.

Moreover, a counterfeiters are increasingly sophisticated regarding their knowledge of a particular industry, and have been known to divert necessary supplies required to produce their counterfeit merchandise, and are also known for outsmarting existing tracking and identification methods.

The widespread availability of market access through the Internet has also enabled the growth of the counterfeit industry. Knowledge derived from the Internet also provides detailed information about potential products to copy as well as links to suppliers and customers, with the result that billions of dollars in counterfeit goods are traded via the Internet each year.

Lastly, as more and more legitimate businesses outsource manufacturing to low-cost manufacturing areas, such as areas in the Pacific Rim, Eastern Europe and South America, these legitimate businesses become targets of counterfeiting activity initiated within their own facilities. Low-cost manufacturing areas typically do not provide significant protections for a company's intellectual property, and the low-cost work force are often motivated to maximize profits from local manufacturing facilities, usually through illegal activities such as bribery, kickbacks and production overruns.

Various methods have been attempted to either foil counterfeiting efforts or to readily identify counterfeit goods. One method utilizes identifying indicia attached to either labels on the product or attached to product packages. In one form, either ultraviolet or infrared readable inks applied to labels or product packaging. Such inks usually require special equipment for detection. In another form, holographic images are applied to predetermined portions of the packaging or to the item itself. While this method may be effective at identifying counterfeit merchandise in its packaged form, labels may be removed either intentionally or as a result of normal product usage, and products or goods will not always be accompanied by packaging. Moreover, many products exist, such as automotive parts or consumables such as food products, that are not easily marked with ink or holographic images, or that experience wear that may degrade the marking indicia. Further, counterfeit goods have been sold in otherwise authentic packaging, obtained either by replacing an authentic item with a counterfeit one, or in some cases, through theft or diversion of authentic packaging. Lastly, advances in computer and printing technology make it relatively easy for counterfeiters to reproduce packaging, even packaging that includes one or more anti-counterfeiting device thereon.

To combat packaging fraud, product manufacturers also permanently etch, machine, or stamp products with identifying indicia, such as with part numbers, trademarks and inventory numbers, and may even involve indicia such as one-dimensional or multi-dimensional machine readable indicia. Such etchings, machinings, or stampings are relatively inexpensive to apply, and unfortunately, are not a deterrent to counterfeiters. In fact, duplication of such marks enhances the credibility of counterfeit items, and often counterfeiters are willing to invest significant resources in mimicking the permanent markings on legitimate goods.

High-cost anti-counterfeiting markings are available for limited production and collectible items, where the value of the item justifies the high cost of the anti-counterfeiting method. However, anti-counterfeiting markings for mass-produced items must be easily and quickly applied, and must not be overly expensive or time-consuming to apply or to distinguish. As an example, one anti-counterfeiting marking used by some manufacturers is a Data Matrix, a two-dimensional machine-detectable marking. Such two-dimensional machine-detectable indicia may be used to identify the product, and may also include limited information relating to inventory, source, destination, But, as noted above, use of a data matrix only invites counterfeiters to include an exact copy of the data matrix on the counterfeit goods.

Thus, a product identification, verification and authentication method is needed that may permanently included on goods, and that allows for inexpensive and simple identification and verification of that good. The product identification, verification and authentication method must be one that is not readily detectable by counterfeiters, and further must be one that is not readily copied by counterfeiters. Preferably, the product identification, verification and authentication method should provide multiple layers of anti-counterfeiting protection.

### SUMMARY OF THE INVENTION

The present invention is directed to an item identification and verification system that embeds a secondary machine-detectable symbology within a primary machine-detectable symbology, preferably as a discrete portion of the primary machine-detectable symbology.

In one embodiment, a primary machine-detectable symbology includes a first decodable multi-dimensional structure and is permanently formed on an item of manufacture. A secondary machine-detectable symbology forms at least a discrete portion of the primary machine-detectable symbology. The secondary machine-detectable symbology may have a second decodable structure that is different from the first decodable multi-dimensional structure of the primary machine-detectable symbology.

The secondary machine-detectable symbology should preferably not be evident to detailed visual inspection of the primary machine-detectable symbology, and more preferably, should be invisible to the unaided human eye. Duplication of the primary machine-detectable symbology by a counterfeiter will therefore not include duplication of the secondary, embedded machine-detectable symbology. For example, a secondary machine-detectable symbology may be embedded as a discrete portion of a Data Matrix. The size and shape of any primary and/or secondary symbology is limited only by the resolution of the etching, stamping or machining technique utilized to permanently attach the symbologies to a product.

Symbologies may be applied via laser etching of each part directly, or may be applied by casting or molding a part such that the symbologies become permanently affixed to the part. If molding or casting, or a similar method is utilized, a rotation-negative inversion image of the symbology may be formed in the mold or casting shell so that a proper, machine-detectable image is formed on the part. Each of the primary and secondary symbologies may further include encoded digital information related to the product, such as information related to tracking, destination, product logistic, product use or the like. The symbologies may be applied with as low as about five percent contrast from surrounding areas, thereby minimizing detectability of any secondary symbology. Currently, only laser etching provides the ability to encode a machine-detectable symbology with as low as about five percent contrast in a size that is not visible to the unaided human eye, but technological advances may lead to other methods of applying the multiple symbologies.

In another embodiment, the system may include an image, where at least a portion of the image includes at least one embedded machine-detectable symbology. The machine-detectable symbology may be used to enhance the presentation of the image, or it may be altogether hidden within the image.

A method for identifying, tracking and verifying an item is also disclosed, wherein a primary machine-detectable symbology is detected and interpreted, and a secondary machine-detectable symbology is detected at a predetermined, discrete location within the primary symbology. In one aspect of the method, the item is identified, tracked, and/or verified only upon detection of the secondary symbology. In another aspect of the method, the item is identified, tracked and/or verified only when the secondary symbology is interpreted, decoded, or is favorably compared with known information.

The system and method presented provides for parts verification, parts authentication, and parts traceability, depending upon the needs of the user. While the system and method may be used with one-dimensional bar codes, it is preferred that the system and method be applied with multi-dimensional machine-detectable symbologies to take advantage of digital intelligence, thereby providing flexibility of encryption/security methods and taking advantage of new methods that are gaining acceptance and momentum in the global business environment. An encryption process provides the customer with an added level of security and provides significantly improved protection against counterfeiters.

Additional objects, advantages, and features will become apparent from the following description and the claims that follow, considered in conjunction with the accompanying drawings.

### BRIEF DESCRIPTION OF THE DRAWINGS

FIG. 1 shows a product permanently marked in accordance with the present invention.

FIG. 2 is an enlarged view of a sample permanent mark.

FIG. 3 is an enlarged view of a portion of FIG. 2, showing a product identification, verification and authentication mark in accordance with the present invention.

FIG. 4 shows the interior of a machine tool marked in accordance with the present invention.

FIG. 5 illustrates the steps of identifying, verifying and authenticating a product permanently marked in accordance with an embodiment of the invention.

### DETAILED DESCRIPTION OF PREFERRED EMBODIMENTS

In the following description, numerous specific details are set forth in order to provide a thorough understanding of various embodiments. It will be apparent to one skilled in the art that the described embodiments may be practiced without some or all of these specific details. In other instances, for purposes of brevity, well-known components and process steps have not been described in detail.

For purposes of this description, terms such as “upper,” “lower,” “right,” “left,” “rear,” “front,” “vertical,” “horizontal,” and the like relate to the embodiment as illustrated and oriented in the figures. It is to be understood that various embodiments may assume alternative orientations, except where expressly specified to the contrary. It is also to be understood that specific devices and processes are described in this disclosure by way of illustration only, and are not intended to be limiting. For example, specific dimensions and other physical characteristics relating to the embodiments described in this disclosure are not to be considered as limiting, unless the claims expressly state otherwise.

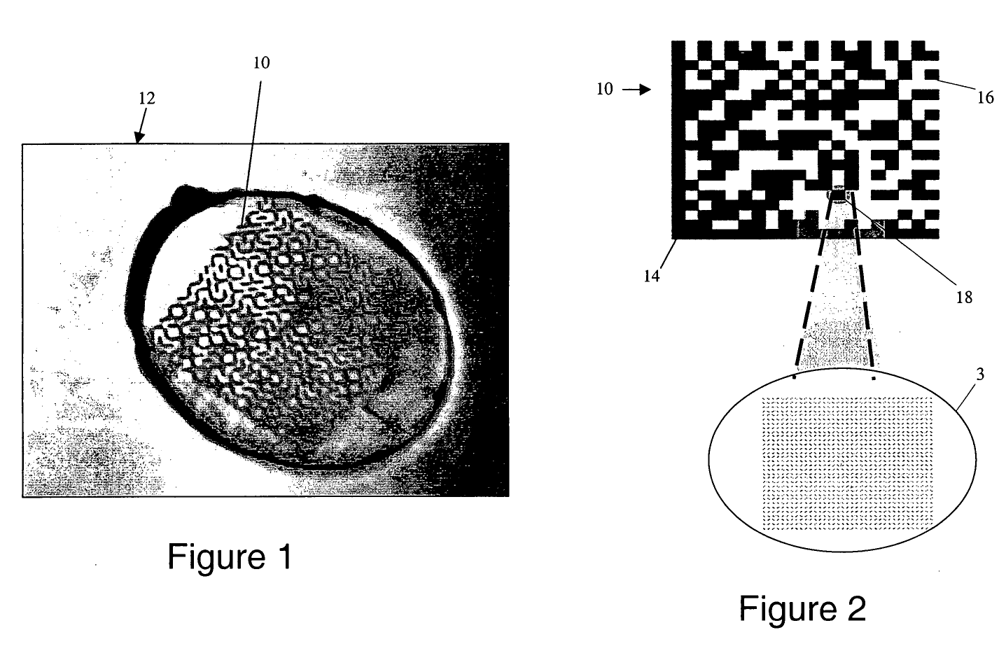

Referring to FIG. 1, a permanent mark 10 is affixed to product 12. In some instances, permanent mark 10 may be the entirety of product 12, as in the case of a photograph, a picture, etc. But, usually, the permanent mark 10 comprises only a discrete portion of product 12. As noted above, product 12 may be any one of automotive parts, electronic components, pharmaceuticals, food products, aircraft parts, consumer goods, sports equipment, computer chips, cosmetics, and chemicals, or any other product on which the product itself, or the packaging for that product, may accept a permanent marking, especially where the packaging is such that the product is never separated therefrom (such as with certain chemicals).

Permanent mark 10 may comprise a logo, a trademark, or other recognizable indicia. However, according to the present invention, and as seen more clearly in FIG. 2, permanent mark 10 preferably comprises a primary multi-dimensional machine-detectable symbology. The permanent mark 10 shown in FIG. 2 is a primary symbology, commonly known as a Data Matrix, and is indicated by reference 14. Like other multi-dimensional markings, a Data Matrix is a very area efficient barcode symbology that uses a unique square module perimeter pattern that helps a scanner determine the cell locations. Because it can encode letters, numbers, text and actual bytes of data, a Data Matrix can encode just about anything including extended characters, unicode characters and photos. Other, similar two-dimensional markings, e.g. Aztec Code, Data Strip Code, MaxiCode, PDF 417, Micro-PDF 417, QR Code, may be used in lieu of a Data Matrix in the present invention. In fact, primary symbology 14 may comprise any type of multi-dimensional machine-detectable marking. While primary symbology 14 may comprise one-dimensional machine-readable images, e.g. one-dimensional bar codes such as UPC, EAN, JAN or UPC128, it is preferred primary symbology 14 be at least a two-dimensional machine-detectable mark.

The two-dimensional primary symbology 14 is comprised of a multitude of sectors 16. Utilizing the algorithms appropriate to the two-dimensional primary symbology 14, user-selectable information may be encoded within primary symbology 14. In fact, it is contemplated that no matter which symbology is used for primary symbology 14, that symbology will include a first decodable multi-dimensional structure that may include encoded user-selectable information.

Multi-dimensional primary symbologies 14 are preferred because it is possible to specify a location for a second, hidden mark at a predetermined location within the multi-dimensional symbology. An advantage of using a multi-dimensional symbology as a primary symbology 14 is that any device configured to read primary symbology 14 will correctly interpret the multi-dimensional symbology no matter the orientation of the primary symbology 14. Moreover, the device configured to read primary symbology 14 will be able to identify the preselected area of primary symbology 14 that contains the secondary symbology. In FIG. 2, primary symbology 14 is a twenty by twenty (20×20) matrix of sectors 16. As a result, the primary symbology 14 shown in FIG. 2 includes 400 discrete sectors 16. According to the present invention, the user may preselect any of the sectors 16 of primary symbology 14 to embed a secondary symbology therewithin. For purposes of illustration, a predetermined sector 18 is chosen in FIG. 2 to contain a secondary, embedded symbology, but it should be understood that any of the sectors may be chosen, alone or in combination with any other sector, to contain a secondary symbology in accordance with the disclosed invention.

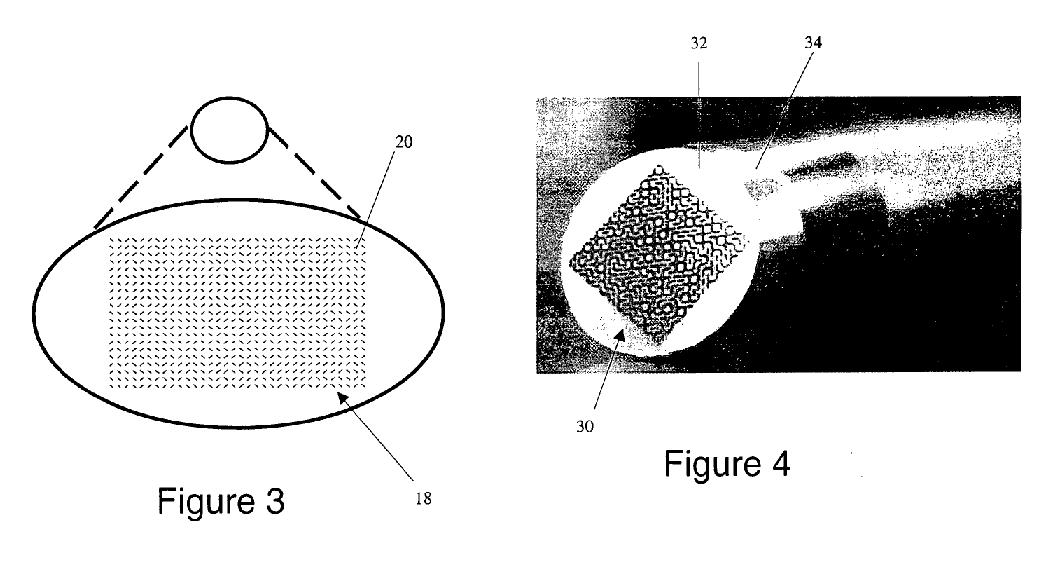

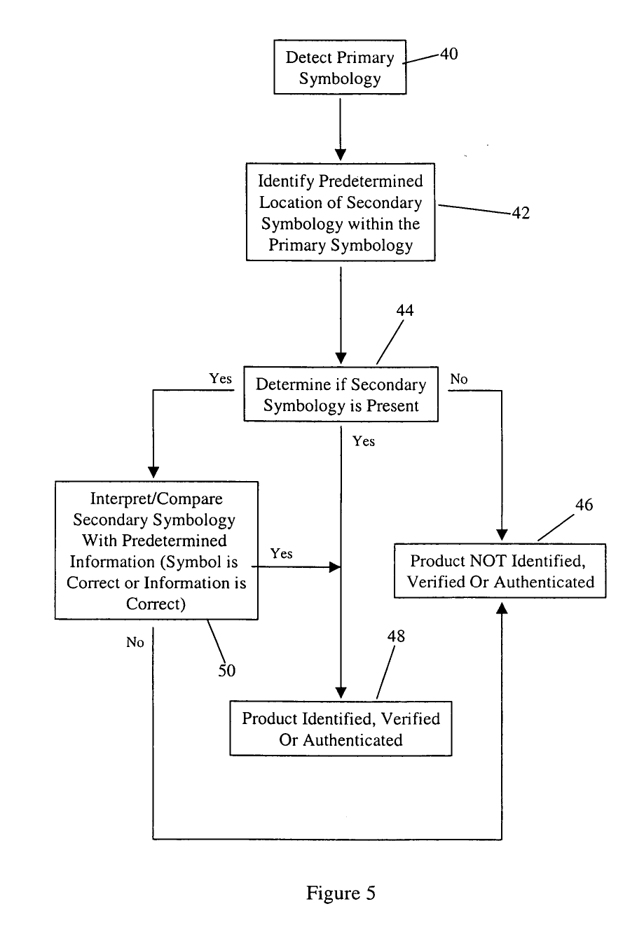

Predetermined sector 18 of primary symbology 14 is magnified and shown in FIG. 3. As can be seen, predetermined sector 18 includes a secondary machine-decodable multi-dimensional symbology 20 formed as at least a discrete portion of primary symbology 14 within sector 18. Preferably, secondary symbology 18 is of a second, different decodable structure than primary symbology 14, though it need not be. The secondary symbology 20 is preferably not evident to detailed visual inspection of the primary symbology 14. This may be accomplished by minimizing the size and contrast of the secondary symbology 20 in relation to the primary symbology 14, or it may be accomplished by including markings similar to the secondary symbology 20 in every sector 16, or across most of, primary symbology 14, or by applying some other combination to minimize the detectability of the secondary symbology 20. In practice, the size and shape of any primary and/or secondary symbology is limited only by the resolution of the etching, stamping or machining technique utilized to permanently attach the symbologies to a product.

As a result, the obvious nature of the primary symbology 14 will invite duplication, but duplication of the primary symbology 14 will not include duplication of an embedded secondary symbology 20. In one aspect of the present invention, a part or item may be identified, verified and/or authenticated simply by detecting the existence of a predefined secondary symbology 20 in a predetermined location within a primary multi-dimensional machine readable symbology, as will be discussed in greater detail below.

The illustrated secondary symbology 20 of FIG. 3 is commonly known as a “glyph” or a “digital glyph.” By way of background, “glyphs” are an embedded digitally readable font, in particular a very fine pattern of machine readable indicia, preferably in very fine patterns of angled slash-mark appearing fonts like “/ΛΛ/Λ\”, etc., (only very much smaller than as shown here). Prior applications confined usage of glyphs to printed documents, and in sizes limited by resolution of the printing medium. However, glyphs are by their very nature typically intended to be optically invisible to the naked eye, not recognizable, not within a clearly defined or bounded area, and are not well known to the public. Thus, their application as a secondary machine-decodable multi-dimensional symbology encoded within a primary machine-decodable multi-dimensional symbology is desirable and appropriate, and is not likely to be detected by a counterfeiter. Moreover, the patterns of angled marks may be incorporated over an entire primary symbology even though only a portion of the pattern of angled marks is used, since the device interpreting the primary symbology is able to identify the location of and limit a scan to a user-selected and predetermined portion of the primary symbology to detect a secondary symbology.

According to the present invention, both the primary symbology 14 and the secondary symbology 20 are designed to be permanently or semi-permanently incorporated into a physical item by lasing, etching, printing, or may be applied by casting or molding, or by any other method known in the art, such that the symbologies become permanently affixed to the part. The data embodied in the digital glyphs can be recaptured and decoded by a suitable decoding device, such as an ordinary video camera, and a computer equipped with appropriate software. Because each of the primary and secondary symbologies are permanently affixed to a part using precise laser etching, machining, stamping, molding, casting, printing or other methods, then each of the primary and secondary symbologies may further include encoded digital information related to the product, such as information related to tracking, destination, product logistics and product use. Moreover, secondary symbology 20 may be pre-encoded with information either identical to, or different from, the information encoded within the primary symbology 14. The flexible nature of usage means that the primary and secondary symbologies may track different aspects of the item, or may be used to verify the information in each respective symbology. And, as mentioned above, primary symbology 14 and secondary symbology 20 preferably have different decodable structures to increase the security and complexity of the markings.

In practice, it is useful to minimize the size of each sector 16 of primary symbology 14 of FIG. 2, because as the number of sectors 16 increases, more digital information may be stored within primary symbology 14. Moreover, the number of locations available in which to apply and conceal the secondary symbology 20 increases as the resolution of the primary symbology 14 increases, and the apparent size of secondary symbology 20 decreases as the resolution of primary symbology 14 increases. In actual application, both the primary and secondary symbologies may be applied to an item with as low as about five percent contrast from surrounding areas. Lower contrast decreases the amount of effort required to apply the primary symbology 14, and also serves to make the secondary symbology 20 virtually undetectable without special equipment. Currently, only laser etching provides the ability to encode a machine readable symbology with as low as about five percent contrast in a size that is not visible to the unaided human eye, but technological advances may lead to other methods of applying the primary and secondary symbologies, and it is contemplated that this invention would encompass future technological advances of the sort. The system and method may also be used with any material able to retain a permanent marking, i.e. steel, stainless steel, cast aluminum, glass, plastic, polymer or rubber, and on any type of surface, i.e. curved, ridged or uneven.

Accurate product identification, verification and authentication of a product containing both primary and secondary symbologies have been made where the height and width of the secondary symbology is less than about 0.8 mm. It is expected that the size of the secondary symbology may be further reduced as technology advances, thereby making the secondary symbology even more difficult for a counterfeiter to detect and duplicate.

As an alternative to laser applications, the invention may be applied directly to parts or items created through an injection molding, casting or similar process. Currently, parts or items created through molding, casting or similar processes are typically identified by attaching a label to the part after manufacture of that part. Unfortunately, parts are susceptible to mis-labeling or mis-identification, either due to an incorrect label being applied to the part or due to the label being applied correctly but not properly adhering to the part. Mis-labeling has adverse consequences for products whose intended use is conveyed by the label, as, for example, a left hand side product being mistaken for a right hand side product. If such a product is mis-labeled and further use to be directed or controlled by the label is contemplated, that further use may be temporarily suspended while the correct product or label is located (e.g. right hand versus left hand product).

To address the problem of mis-labeling parts created in a molding, casting or similar processes may be formed with an integrally formed identifying permanent mark as part of the molding, casting or similar process. In this embodiment, a rotation-negative inversion image of the primary symbology, often including the secondary symbology, may be formed on the mold or casting shell so that a proper, machine readable image is formed on the part when the part is produced. A “rotation-negative inversion image” is equivalent of a photographic negative view of the symbological marks.

As shown in FIG. 4, instead of individually permanently applying a machine-detectable symbology to each part, thereby requiring a separate manufacturing step, a rotation-negative inversion image 30 of the machine readable symbology is applied to the inside surface 32 of a machine tool 34 (e.g. a mold or casting block or the like) to achieve sufficient image size, contrast and location. The image 30 formed on the inside surface 32 of the machine tool 34 may either be etched into the tool to provide a raised image on the finished product, or area around the image may be etched away to form an indented image on the finished product. On average, an etched rotation-negative inversion image has been found to require a depth of twenty thousandths of an inch (0.020 inches) in a hardened steel mold to provide a sufficient raised machine-detectable image on plastic injection molded parts. When combined with a machine-detectable symbology utilizing an eighty-percent error correction routine, the first-read image detection exceeded ninety-nine percent detection and accuracy.

Using this method, at least a primary symbology may be included as a permanent portion of commonly molded or cast items, and the opportunity for a secondary symbology is available for embedding within the primary symbology. Labels applied after manufacture may be eliminated, as are all errors associated with mis-labeling or lost labels. Moreover, costs attendant to labels, including the label paper, printer and ink, will also be eliminated in favor of a one-time cost to mark the inside of the die, mold or casting block with the rotation-negative inversion mark.

In one embodiment, the system may include an image, where at least a portion of the image hides at least one machine readable symbology. The machine-readable symbologies may be used to enhance the presentation of the image, or they may be altogether hidden in the main image for any purpose related to identification, authentication, brand protection, or traceability.

A method is also provided for identifying, verifying and authenticating a product permanently marked in accordance with the present invention. As seen in FIG. 4, the method comprises a first step 40, wherein a primary symbology is detected on a part. Once the primary symbology is detected on the part, a predetermined location, preferably predetermined by the parts manufacturer or other persons, is identified as the location for any embedded secondary symbology. This method step is identified as reference 42 in FIG. 4. Once the predetermined location is identified, that location is scanned (reference 44) for the presence of a secondary symbology. According to one aspect of the present invention, if the secondary symbology is not present or located at the predetermined location, then the product is not identified, verified or authenticated, indicated by reference 46. According to a second aspect of the present invention, the product is identified, verified or authenticated only if the secondary symbology is determined to be present, as indicated by reference 48. Thus, the mere existence of a secondary symbology provides identification, verification and authentication information.

However, the secondary symbology is also capable of including further, user selectable, information. In a third aspect of the present invention, an intervening step 50 is contemplated, wherein, after the secondary symbology is determined to be present in step 44, the secondary symbology is interpreted, or decoded, or otherwise compared with known, predetermined information. The predetermined information contained in the secondary symbology may include information that is identical to the information carried by the primary symbology, and may therefore be compared thereto, or the secondary symbology may include user predetermined information that is different from the information carried by the primary symbology.

Unlike normal bar codes, the system and method of the present invention require significantly less contrast for reading both the primary and secondary symbologies. Moreover, use of symbologies in accordance with the present invention eliminates the requirement for “quiet zones” (i.e., a blank area surrounding the mark) to get an accurate read. Since the symbologies are permanently applied to the part or item, the system and method of the present invention may be subjected to harsh environments that labels and other markings could not withstand, and may even incur damage without affecting decoding accuracy because of potential self-correcting features of the symbologies. Moreover, the embedding of a secondary symbology within a primary symbology, where the secondary symbology is not readily evident, invites the counterfeiter to copy the primary symbology. A counterfeiter is not likely to detect the secondary symbology, especially if the secondary symbology is camouflaged within the primary symbology. Since verification occurs only with detection of the secondary symbology, counterfeit goods that include only the primary symbology will be easily detectable.

It will be understood by those skilled in the art that various modifications and improvements may be made without departing from the spirit and scope of the disclosed embodiments. The scope of protection afforded is to be determined solely by the claims and by the breadth of interpretation allowed by law.

What is claimed is:

1. An item identification and verification system, comprising:
a primary symbology formed on the item, said primary symbology having a first structure;
a secondary symbology forming at least a discrete portion of said primary symbology,
wherein said second symbology is machine detectable.

2. The system of claim 1, wherein said primary symbology is machine-detectable.

3. The system of claim 2, wherein said secondary symbology is machine-detectable.

4. The system of claim 3, wherein said primary symbology has a first decodable structure.

5. The system according to claim 4, wherein said first structure is a decodable two-dimensional structure.

6. The system according to claim 4, wherein said secondary machine-detectable symbology has a second decodable structure that is different from said first decodable structure.

7. The system of claim 1, wherein said primary symbology is permanently formed on the item.

8. The system of claim 1, wherein said secondary symbology is not readily visible to the unaided human eye.

9. The system according to claim 1, wherein said second symbology has a height and a width less than about 0.8 millimeters.

10. The system according to claim 1, wherein said primary symbology is an image.

11. An item identification and verification system, comprising:
a primary machine-detectable symbology formed on the item, said primary machine-detectable symbology having a first decodable structure; and
a secondary machine-detectable symbology forming at least a discrete portion of said primary symbology.

12. The system of claim 11, wherein said secondary machine-detectable symbology has a second decodable structure that is different from said first decodable structure.

13. The system of claim 12, wherein said first decodable structure is multi-dimensional.

14. The system of claim 13, wherein said primary symbology and said secondary symbology are encoded with identical information.

15. The system of claim 13, wherein said primary symbology and said secondary symbology are encoded with different information.

16. The system of claim 11, wherein said primary symbology is permanently formed on the item.

17. The system of claim 11, wherein said secondary symbology is embedded within said primary symbology, said secondary symbology formed with less than about ten percent contrast.

18. The system of claim 11, wherein the item is a machine tool, and wherein said primary symbology is formed as a rotation-negative inversion image on said machine tool.

19. A method for identifying and verifying an item, comprising:
detecting an image on the item, said image comprising a primary machine-detectable symbology; and
detecting the presence of a secondary machine-detectable symbology, said secondary symbology forming at least a discrete portion of said primary symbology at a predetermined location within said primary symbology, wherein detection of said second symbology within said first symbology provides product identification or verification.

20. The method of claim 19, further comprising the steps of:
decoding the contents of a decodable structure associated with said second symbology; and
comparing said contents with predetermined information.
